(19) United States
(12) Patent Application Publication
(10) Pub. No.: US 2014/0175877 A1
(43) Pub. Date: Jun. 26, 2014

(54) Building Power Management System

(71) Applicant: William Baker, Indianapolis, IN (US)

(72) Inventor: William Baker, Indianapolis, IN (US)

(21) Appl. No.: 13/987,599

(22) Filed: Aug. 13, 2013

Related U.S. Application Data
(60) Provisional application No. 61/742,527, filed on Aug. 13, 2012.

(51) Int. Cl. H02J 4/00; H02H 3/22

(52) U.S. Cl. CPC H02J 4/00; H02H 3/22
USPC 307/23; 307/39; 307/36; 361/118

(57) ABSTRACT

A building power management system employs a power manager and a plurality of load circuits (e.g., outlet circuits, appliances, equipment, etc.). In operation, the power manager senses (directly or indirectly) a source voltage at a power source node, sheds one or more of the load circuits from a power source node in response to the source voltage sagging below a source voltage limit, and reconnects shedded load circuit(s) to the power source node upon the source voltage exceeding the source voltage limit. Further, the program manager senses (directly or indirectly) a source current flowing through the power source node, sheds one or more of the load circuits from the power source node in response to the source current exceeding a source current limit, and reconnects shedded load circuit(s) to the power source node upon the source current sagging below the source current limit.

This application claims benefit of priority under U.S. provisional application Ser. No. 61/742,527 filed Aug. 13, 2102, which is hereby incorporated in its entirety by reference.

The present invention generally relates to a power management system for logically shedding load circuits to maintain power being managed by the system within definable limits. The present invention specifically relates to a power management system for shedding (i.e., disconnecting) load circuits from a power source node of a building, preferably in a priority sequence, when a source voltage sags below a source voltage limit and/or a source current exceeds a source current limit.

A circuit breaker system in a building of any type (e.g., a house, a hospital, a hotel, an industrial plant, an office building, a sports facility, etc.) is designed to break an individual load circuit's connection to a power source node when the load current exceeds a current limit. However, the circuit breaker system does not incorporate any type of shedding load circuit procedure that will enable the circuit breaker to shed (i.e., disconnect) load circuits from a power source node, preferably in a priority sequence, when a source current exceeds a source current limit and/or a source voltage sags below a source voltage limit.

One form of the present invention is a building power management system employing a power manager and a plurality of load circuits (e.g., outlet circuits, appliances, equipment, etc.). In operation, the power manager senses (directly or indirectly) a source voltage at a power source node, sheds one or more of the load circuits from a power source node in response to the source voltage sagging below a source voltage limit, and reconnects shedded load circuit(s) to the power source node upon the source voltage exceeding the source voltage limit. Further, the program manager senses (directly or indirectly) a source current flowing through the power source node, sheds one or more of the load circuits from the power source node in response to the source current exceeding a source current limit, and reconnects shedded load circuit(s) to the power source node upon the source current sagging below the source current limit.

Another form of the present invention is a building power management method for a power manager and a plurality of load circuits. The method involves operating the power manager to (a) sense (directly or indirectly) a source voltage at a power source node, (b) shed one or more load circuits from the power source node in response to the source voltage sagging below a source voltage limit, and (c) reconnect shedded load circuit(s) to the power source node upon the source voltage exceeding the source voltage limit. The method further involves the power manager operating the power manager to (a) sense (directly or indirectly) a source current flowing through the power source node, (b) shed one or more load circuits from the power source node in response to the source current exceeding a source current limit, and (c) reconnect shedded load circuit(s) to the power source node upon the source current sagging below the source current limit.

The foregoing forms and other forms of the present invention as well as various features and advantages of the present invention will become further apparent from the following detailed description of various exemplary embodiments of the present invention read in conjunction with the accompanying drawings. The detailed description and drawings are merely illustrative of the present invention rather than limiting, the scope of the present invention being defined by the appended claims and equivalents thereof.

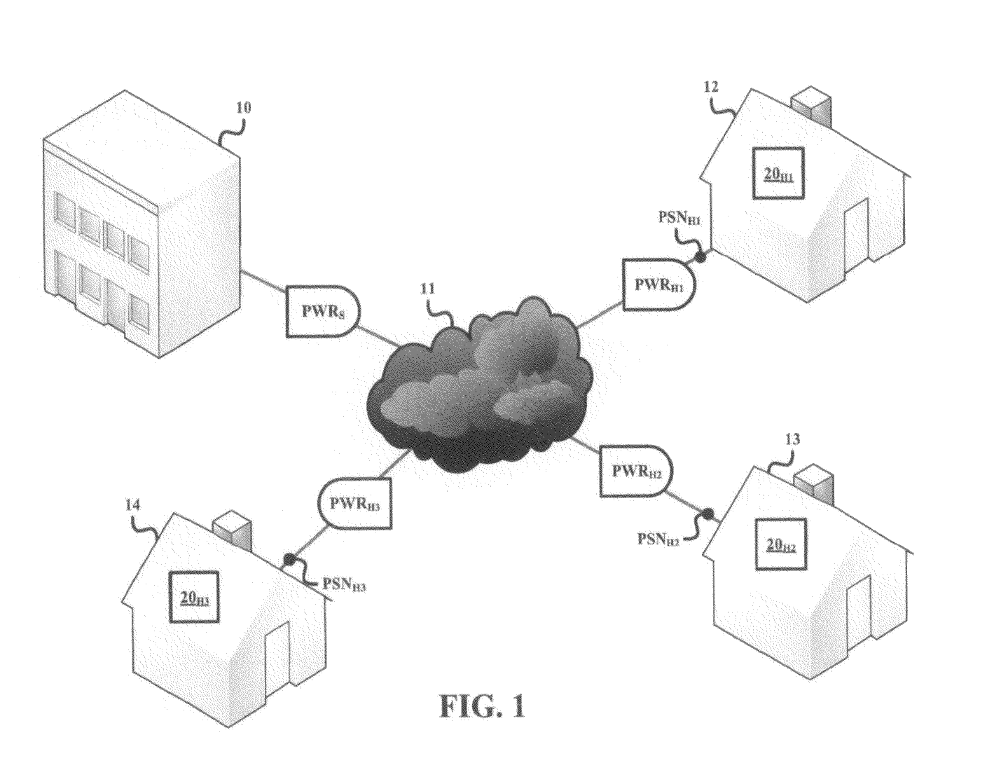

FIG. 1 illustrates an exemplary environment for implementing a power management system in accordance with the present invention.

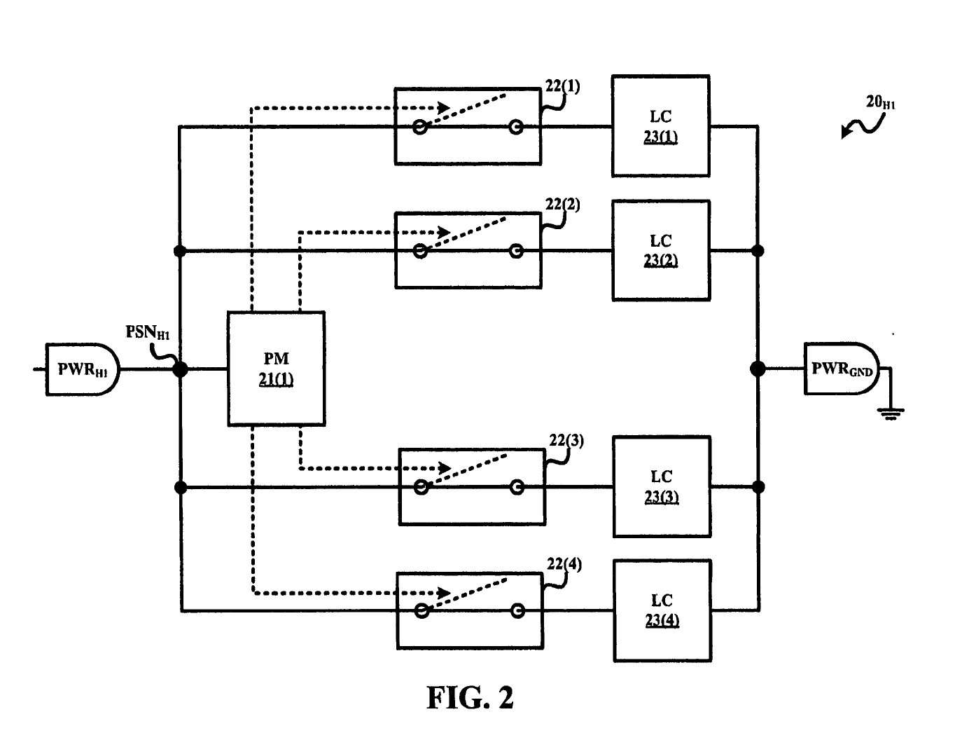

FIG. 2 illustrates a first exemplary embodiment of a power management system in accordance with the present invention.

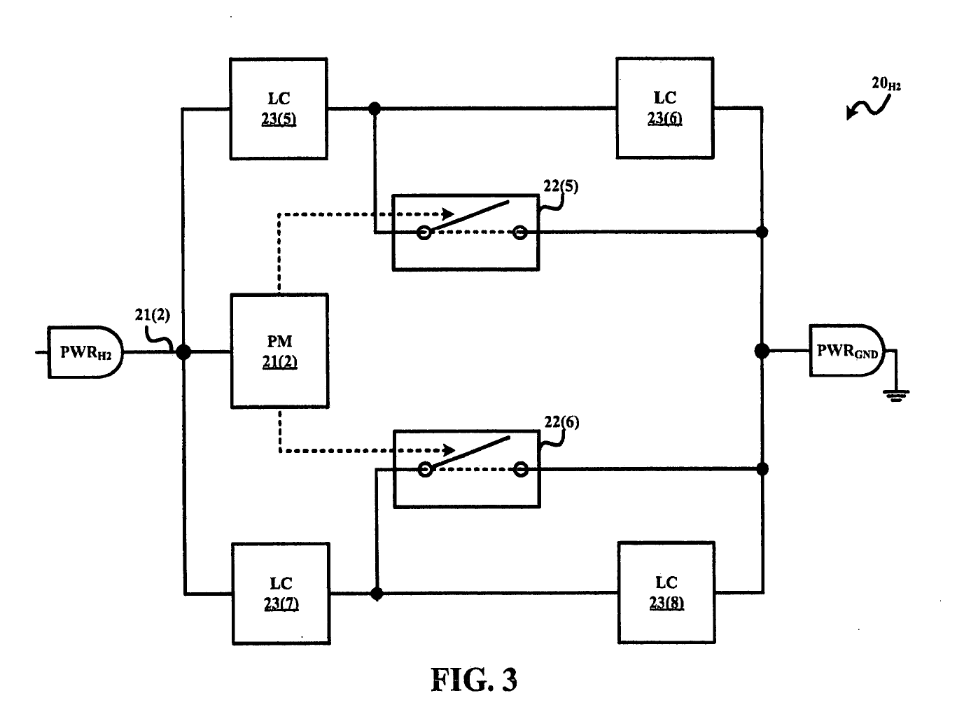

FIG. 3 illustrates a second exemplary embodiment of a power management system in accordance with the present invention.

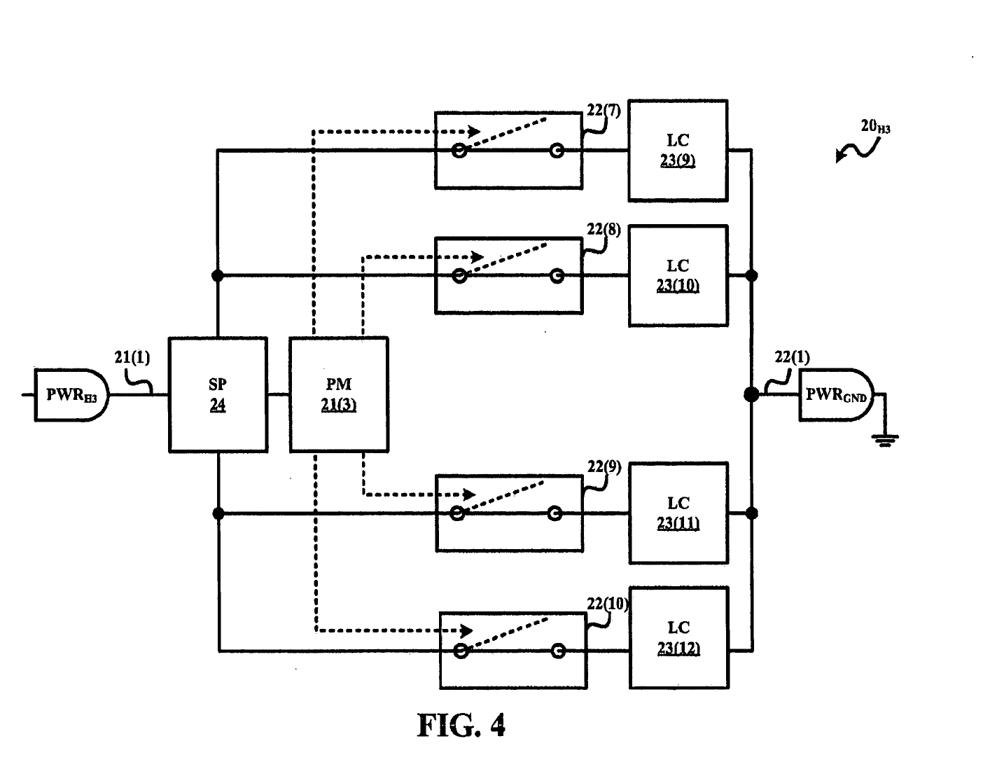

FIG. 4 illustrates a third exemplary embodiment of a power management system in accordance with the present invention.

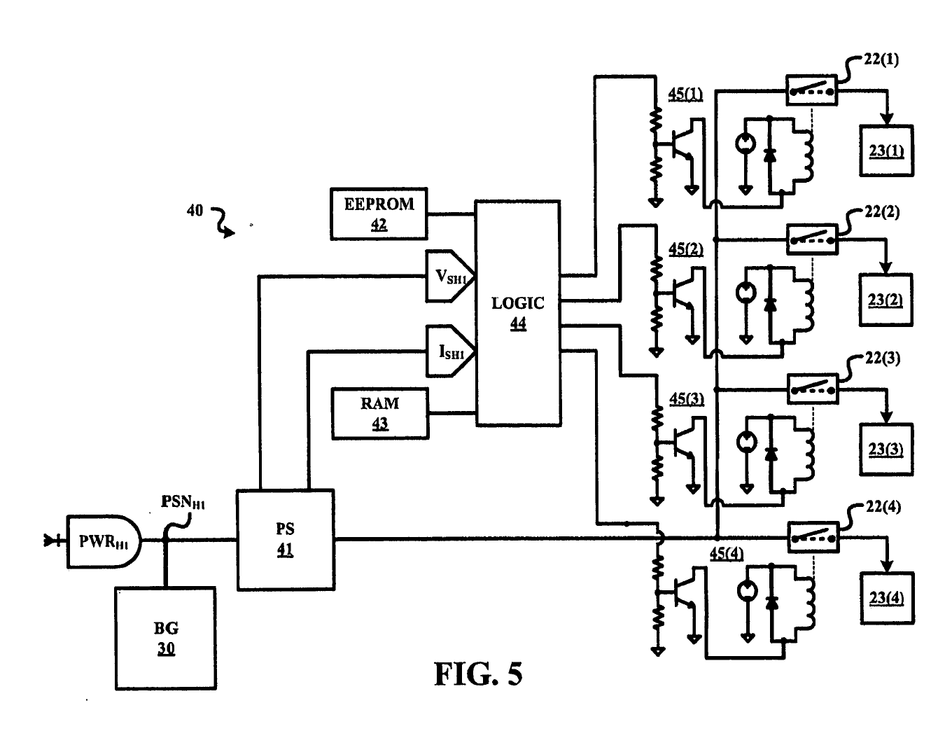

FIG. 5 illustrates a fourth exemplary embodiment of a power management system in accordance with the present invention.

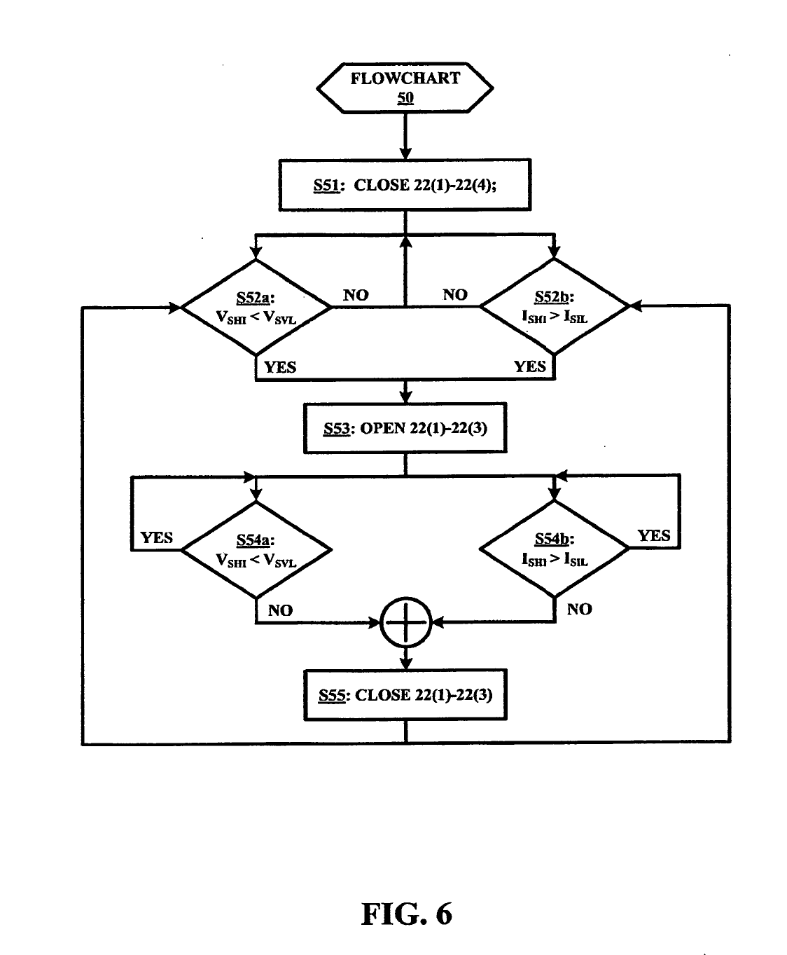

FIG. 6 illustrates a flowchart representative of a first exemplary embodiment of a power management method of the present invention.

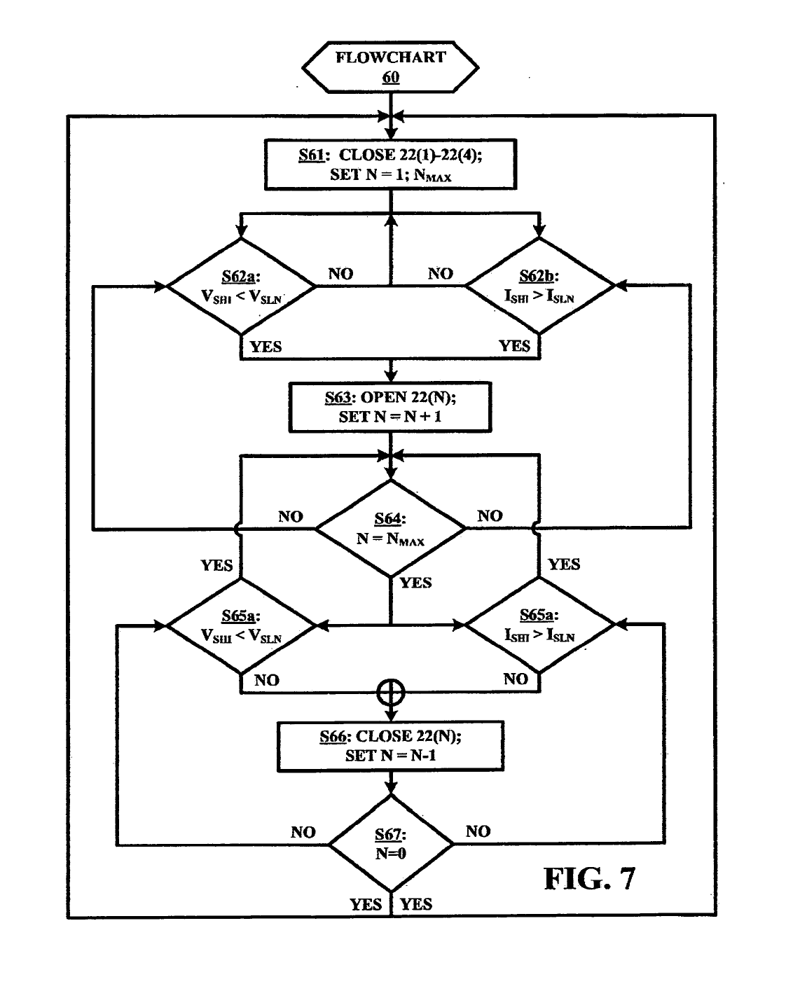

FIG. 7 illustrates a flowchart representative of a second exemplary embodiment of a power management method of the present invention.

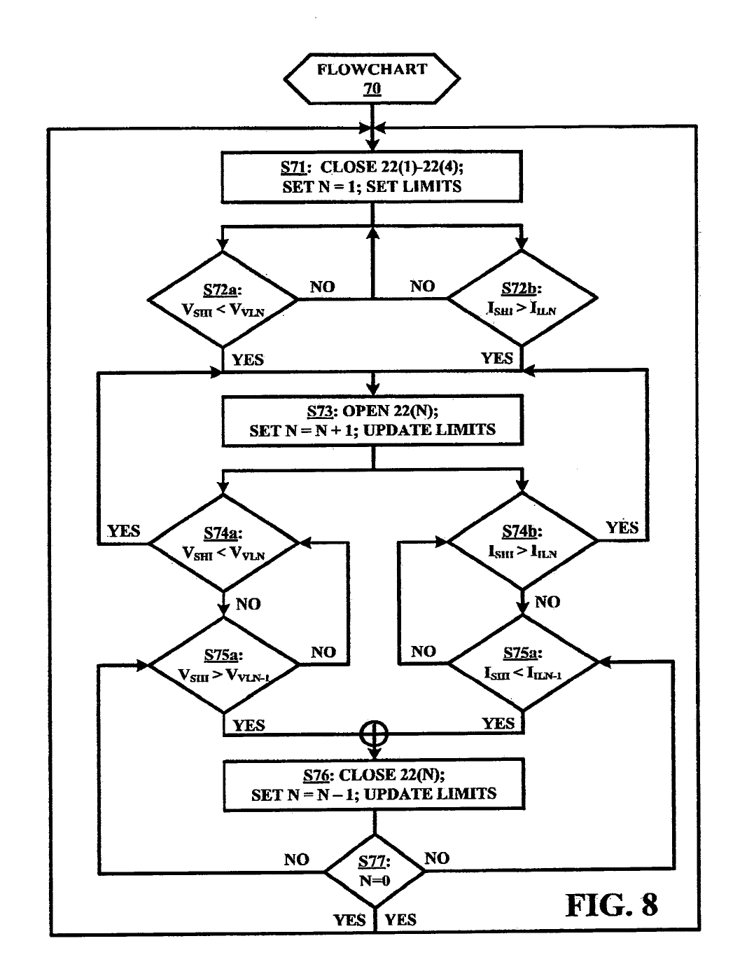

FIG. 8 illustrates a flowchart representative of a third exemplary embodiment of a power management method of the present invention.

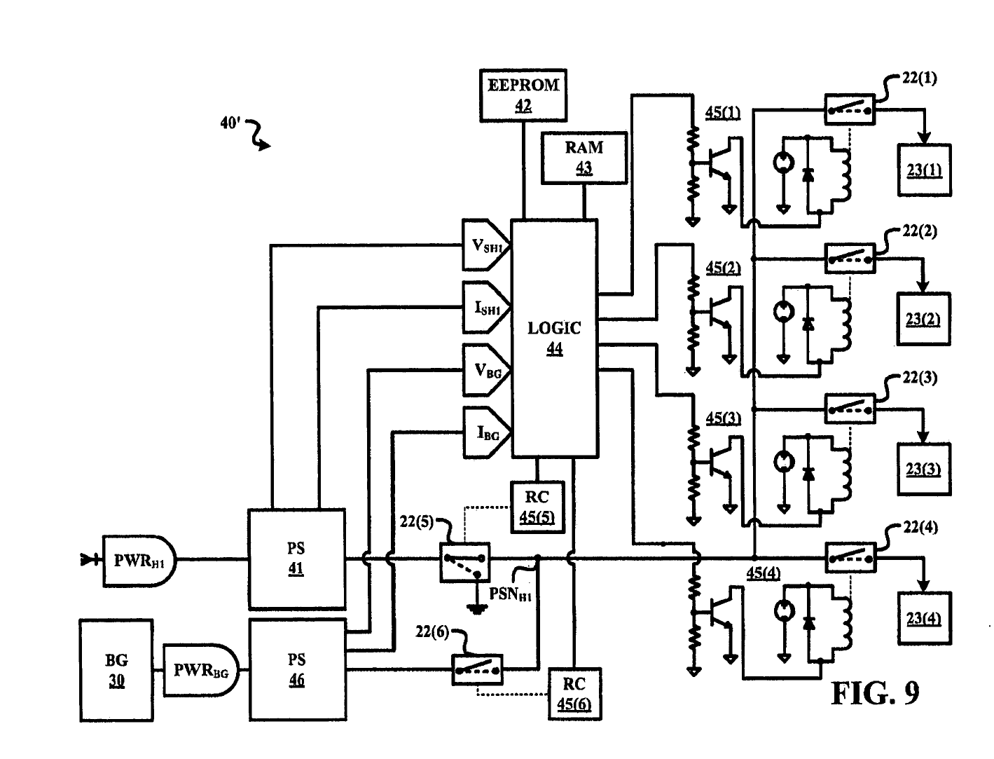

FIG. 9 illustrates a fifth exemplary embodiment of a power management system in accordance with the present invention.

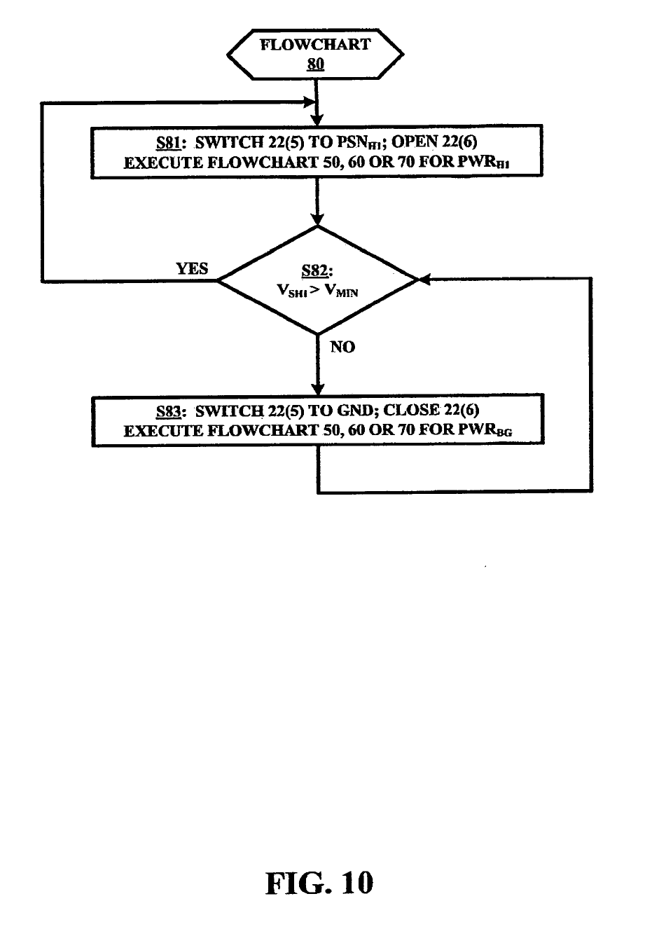

FIG. 10 illustrates a flowchart representative of a fourth exemplary embodiment of a power management system in accordance with the present invention.

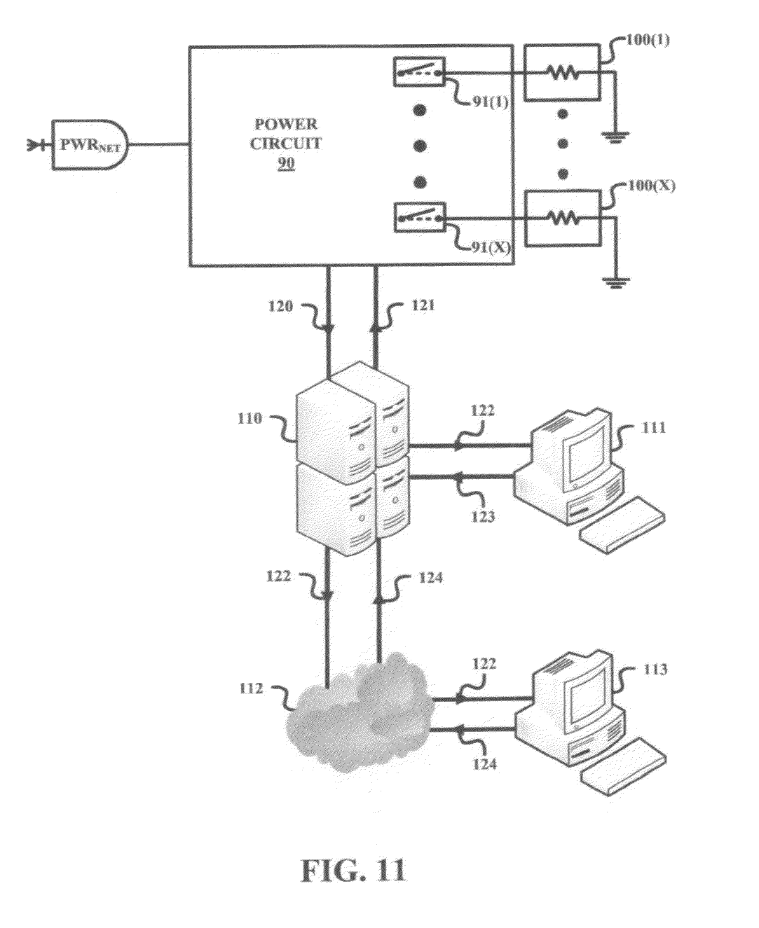

FIG. 11 illustrates a sixth exemplary embodiment of a power management system in accordance with the present invention.

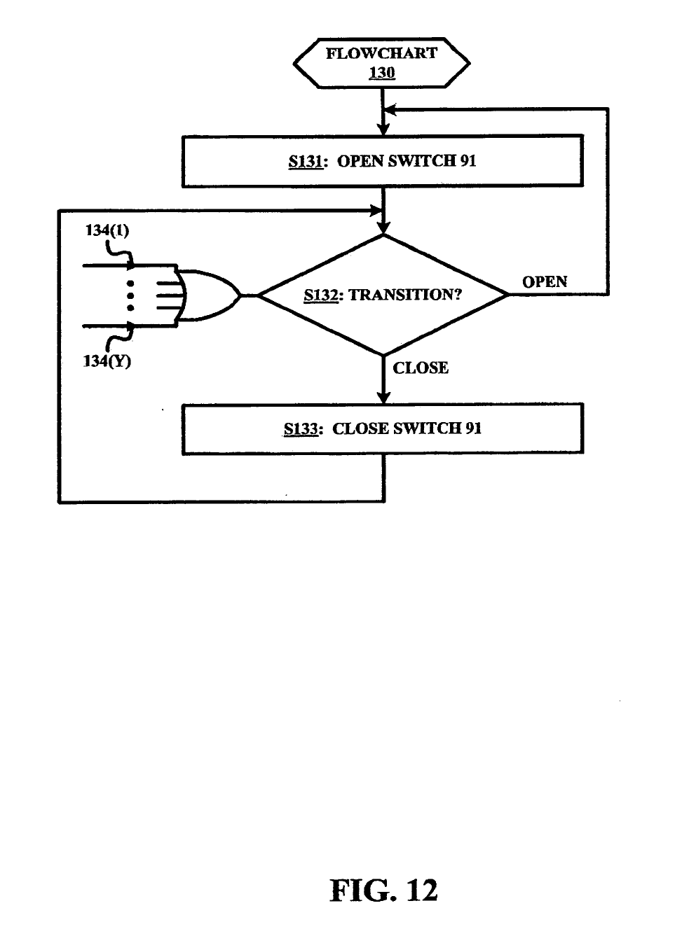

FIG. 12 illustrates a flowchart representative of one exemplary embodiment of a power circuit control method in accordance with the present invention.

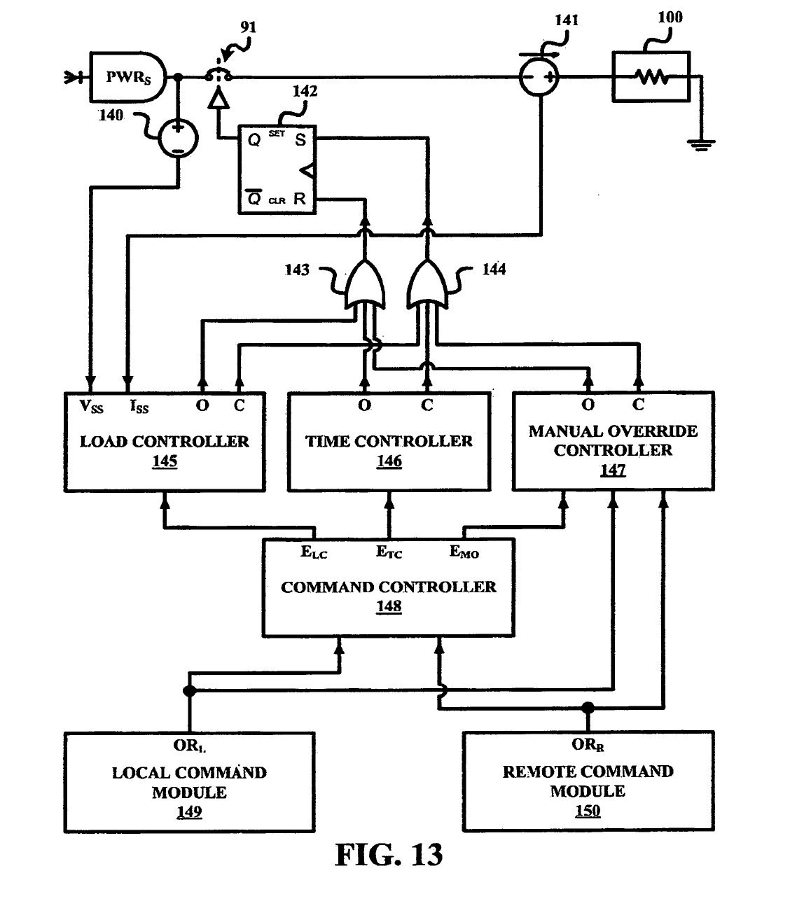

FIG. 13 illustrates one exemplary embodiment of a command structure of the power management system in accordance with the present invention.

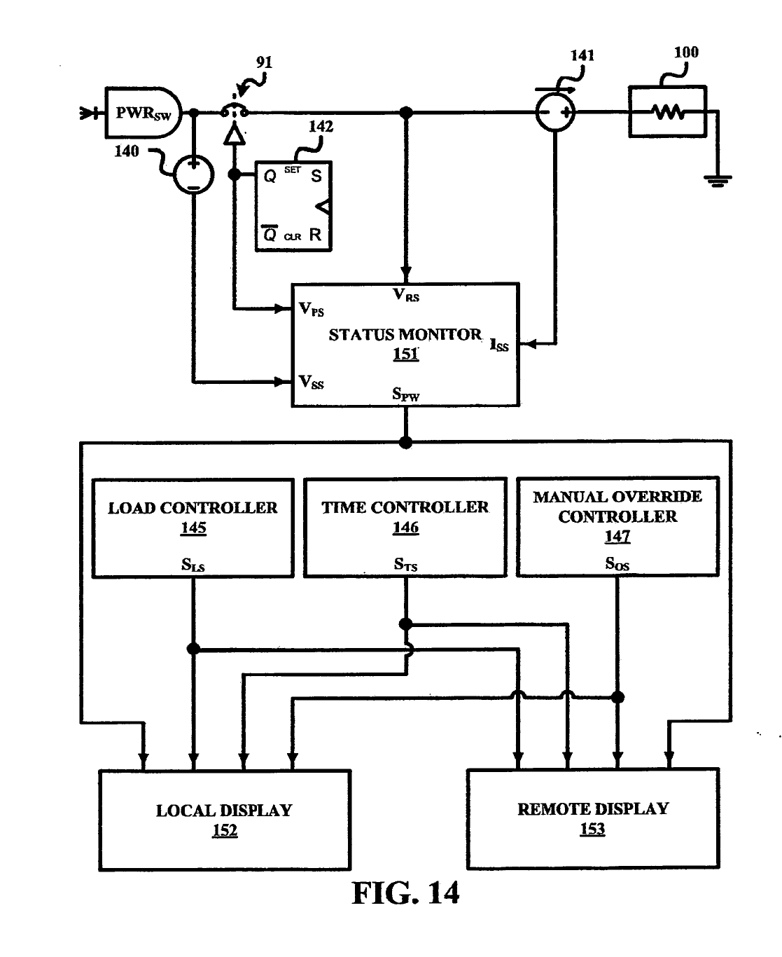

FIG. 14 illustrates one exemplary embodiment of a status structure of the power management system in accordance with the present invention.

Referring to FIG. 1, a power source 10 (e.g., a utility) generates source power PWRs for powering three (3) buildings 12-14 via a network 11. While buildings 12-14 shown in FIG. 1 are homes, in practice, buildings 12-14 may be any type of building (e.g., a house, a hospital, a hotel, an industrial plant, an office building, a sports facility, etc.).

Contained within buildings 12-14 are a various types of load circuits (e.g., outlet circuits, appliances, equipment, etc.). For each building 12-14, the present invention provides a power management system 20 for shedding (i.e., disconnecting) the load circuits from a power source node of the building, preferably in a priority sequence, when a source voltage sags below a source voltage limit and/or a source current exceeds a source current limit. Conversely, each power management system 20 reconnects shedded load circuit(s) to the power source node of the building, preferably in a priority sequence, when the source voltage exceeds the source voltage limit and/or a source current sags below the source current limit.

Specifically, building 12 incorporates a power management system 20_{H1} of the present invention for managing a source power PWR_{H1} received from power source 10 via network 11 to a power source node PSN_{H1}. Similarly, building 13 incorporates a power management system 20_{H2} of the present invention for managing a source power PWR_{H2} received via network 11 to a power source node PSN_{H2}, and building 14 incorporates a power management system 20_{H3} of the present invention for managing a source power PWR_{H3} received via network 11 to a power source node PSN_{H3}.

In operation, power management system 20_{H1} implements a power manager method of the present invention for shedding/reconnecting load circuits within building 12 from/to a power source node PSN_{H1} feeding source power PWR_{H1} into building 12. Source power PWR_{H1} includes a source voltage applied to power source node PSN_{H1} and power management system 20_{H1} senses (directly or indirectly) the source voltage whereby power management system 20_{H1} selectively sheds and reconnect one or more load circuits within building 12 from power source node PSN_{H1} based on a comparison of the source voltage to a source voltage limit. For example, power management system 20_{H1} sheds one or more load circuits within building 12 from power source node PSN_{H1} in response to the source voltage of source power PWR_{H1} sagging below a source voltage limit of 90 VAC. Thereafter, power management system 20_{H1} reconnects the shedded load circuit(s) within building 12 to power source node PSN_{H1} in response to the source voltage of source power PWR_{H1} exceeding the source voltage limit of 90 VAC.

Furthermore, source power PWR_{H1} includes a source current flowing through power source node PSN_{H1} and power management system 20_{H1} senses (directly or indirectly) the source current whereby power management system 20_{H1} selectively sheds and reconnects one or more load circuits within building 12 from power source node PSN_{H1} based on a comparison of the source current to a source current limit. For example, power management system 20_{H1} sheds one or more load circuits within building 12 from power source node PSN_{H1} in response to the source current of power PWR_{H1} exceeding a source current limit of 25 amps. Thereafter, power management system 20_{H1} reconnects shedded load circuit(s) within building 12 to power source nodes PSN_{H1} in response to the source current of source power PWR_{H1} sagging below the source voltage limit of 25 amps.

Similarly, power management system 20_{H2} implements a power manager method of the present invention for shedding/reconnecting load circuits within building 13 from/to power source nodes PSN₁₁₂ feeding source power PWR_{H2} into building 13, and power management system 20_{H3} implements a power manager method of the present invention for shedding/reconnecting load circuits within building 14 from/to power source nodes PSN_{H3} feeding source power PWR_{H3} into building 14.

FIGS. 2-4 illustrate exemplary embodiments of power management systems 20 to facilitate an understanding of various circuit arrangements of the power management system of the present invention. Referring to FIG. 2, power management system 20_{H1} employs a power manager 21(1) for selectively opening and closing relays 22(1)-22(4) based on a comparison of the source voltage of source power PWR_{H1} applied at power source node PSN_{H1} to a source voltage limit and a comparison of the source current of source power PWR_{H1} flowing through power source node PSN_{H1} to a source current limit. The selectively opening and closing of relays 22(1)-22(4) by power manager 21(1) sheds and reconnects load circuits 23(1)-23(4) within building 12 from power source node PSN_{H1}.

For example, FIG. 2 shows relays 22(1)-22(4) in a closed state whereby load circuits 23(1)-23(4) are being powered via source power PWR_{H1}. Power manager 21(1) opens one or more of relays 22(1)-22(4) as indicated by the dashed arrow in response to the source voltage of source power PWR_{H1} sagging below a source voltage limit of 90 ac to thereby shed one or more load circuits 23(1)-23(4) from power source node PSN_{H1}. Thereafter, power manager 21(1) recloses the opened relays 22(1)-22(4) in response to the source voltage of source power PWR_{H1} exceeding the source voltage limit of 90 VAC to thereby reconnect the shedded load circuit(s) 23(1)-23(4) within building 12 to power source node PSN_{H1}.

Additionally, power manager 21(1) opens one or more of relays 22(1)-22(4) as indicated by the dashed arrow in response to the source current of source power PWR_{H1} exceeding a source current limit of 25 amps to thereby shed one or more load circuits 23(1)-23(4) from power source node PSN_{H1}. Thereafter, power manager 21(1) reclosed the opened relays 22(1)-22(4) in response to the source current of source power PWR_{H1} sagging below the source current limit of 25 amps to thereby reconnect the shedded load circuit(s) 23(1)-23(4) within building 12 to power source node PSN_{H1}.

Referring to FIG. 3, power management system 20_{H2} employs a power manager 21(2) for selectively opening and closing relays 22(5) and 22(6) based on a comparison of the source voltage of source power PWR_{H2} applied at power source node PSN_{H2} to a source voltage limit and a comparison of the source current of source power PWR_{H2} flowing through power source node PSN_{H2} to a source current limit. The selectively opening and closing of relays 22(5) and 22(6) by power manager 21(2) sheds and reconnects load circuits 23(6) and 23(8) within building 13 from power source node PSN_{H2}.

For example, FIG. 3 shows relays 22(5) and 22(6) in an open state whereby load circuits 23(5)-23(8) are being powered via source power PWR_{H2}. Power manager 21(2) closes one or more of relays 22(5) and 22(6) as indicated by the dashed arrow in response to the source voltage of source power PWR_{H2} sagging below a source voltage limit of 90 VAC to thereby shed one or more load circuits 23(6) and 23(8) from power source node PSN_{H2}. Thereafter, power manager 21(2) reopens the closed relays 22(5) and 22(6) in response to the source voltage of source power PWR_{H2} exceeding the source voltage limit of 90 VAC to thereby reconnect the shedded load circuit(s) 23(6) and 23(8) within building 13 to power source node PSN_{H2}.

Additionally, power manager 21(2) closes one or more of relays 22(5) and 22(6) as indicated by the dashed arrow in response to the source current of source power PWR_{H2} exceeding a source current limit of 25 amps to thereby shed one or more load circuits 23(6) and 23(8) from power source node PSN_{H2}. Thereafter, power manager 21(2) reopens the closed relays 22(5) and 22(6) in response to the source current of source power PWR_{H2} sagging below the source current limit of 25 amps to thereby reconnect the shedded load circuit(s) 23(6) and 23(8) within building 13 to power source node PSN_{H2}.

Referring to FIG. 4, power management system 20_{H3} employs a power manager 21(3) for selectively opening and closing relays 22(7)-22(10) based on a comparison of the source voltage of source power PWR_{H3} applied at power source node PSN_{H3} to a source voltage limit and a comparison of the source current of source power PWR_{H3} flowing through power source node PSN_{H3} to a source current limit. The selectively opening and closing of relays 22(7)-22(10) by power manager 21(3) sheds and reconnects load circuits 23(9)-23(12) within building 14 from power source node PSN_{H3}. Power management system 20_{H3} further employs a surge protector 24 for protecting power manager 21(3) and load circuits 23(9)-23(12) from power surges.

For example, FIG. 4 shows relays 22(7)-22(10) in a closed state whereby load circuits 23(9)-23(12) are being powered via source power PWR_{H3}. Power manager 21(3) opens one or more of relays 22(7)-22(10) as indicated by the dashed arrow in response to the source voltage of source power PWR_{H3} sagging below a source voltage limit of 90 VAC to thereby shed one or more load circuits 23(9)-23(12) from power source node PSN_{H3}. Thereafter, power manager 21(3) recloses the opened relays 22(7)-22(10) in response to the source voltage of source power PWR_{H3} exceeding the source voltage limit of 90 VAC to thereby reconnect the shedded load circuit(s) 23(9)-23(12) within building 14 to power source node PSN_{H3}.

Additionally, power manager 21(3) opens one or more of relays 22(7)-22(10) as indicated by the dashed arrow in response to the source current of source power PWR_{H3} exceeding a source current limit of 25 amps to thereby shed one or more load circuits 23(9)-23(12) from power source node PSN_{H3}. Thereafter, power manager 21(3) reclosed the opened relays 22(7)-22(10) in response to the source current of source power PWR_{H3} sagging below the source current limit of 25 amps to thereby reconnect the shedded load circuit(s) 23(9)-23(12) within building 14 to power source node PSN_{H3}.

As previously stated herein, those having skill in the art will appreciate the various circuit arrangements of a power management system of the present invention from the description of FIGS. 2-4.

FIG. 5 illustrates an exemplary embodiment of power management system 20_{H1} as shown in FIG. 2 to facilitate an understanding of various embodiments of the power management system of the present invention.

Referring to FIG. 5, power manager 21(1) is implemented as a power manager 40 employing a power sensor 41, an EEPROM 42, a RAM 43, ALU 44 and relay controls 45(1)-45(4) for selectively opening and closing relays 22(1)-22(4) to thereby shed and reconnect respective load circuits 23(1)-23(4) based on a comparison of the source voltage of source power PWR_{H1} applied at power source node PSN_{H1} to a source voltage limit stored in EEPROM 42 and a comparison of the source current of source power PWR_{H3} flowing through power source node PSN_{H1} to a source current limit stored in EEPROM 42. Source power PWR_{H3} is derived from power source 10 (FIG. 1) or a backup generator 30.

Various exemplary operations of power manager 40 will now be described in connection with the flowcharts shown in FIGS. 6-8.

Referring to FIG. 6, flowchart 50 represents a power management method of the present invention whereby relay 22(4) is a priority relay that always stays closed. As such, relays 22(1)-22(3) are opened if the source voltage sags below the source voltage limit and/or the source current exceeds the source current limit and whereby relays 22(1)-22(3) are reclosed if the source voltage exceeds the source voltage limit and the source current sags below the source current limit.

Specifically, a stage S50 of flowchart 50 encompasses power manager 40 closes all relays 22(1)-22(4). If a stage S52a of flowchart 50 indicates source voltage V_{SHI} is below source voltage limit V_{SVL} and/or stage S52b of flowchart 50 indicates source current I_{SHI} exceeds source current limit I_{SIL}, then power manager 40 only opens relays 22(1)-22(3) during a stage S53 of flowchart 50. Thereafter, if a stage S54a of flowchart 50 indicates source voltage V_{SHI} exceeds source voltage limit V_{SVL} and stage S54b of flowchart 50 indicates source current I_{SHI} is below source current limit I_{SIL}, then power manager 40 reopens closed relays 22(1)-22(3) during a stage S55 of flowchart 50 and returns to stages S52a and S52b.

Referring to FIG. 7, flowchart 60 represents a power management method of the present invention whereby relays 22 are opened in a priority sequence from relay 22(1) up to 22(4) in dependence upon relay limit N_{MAX}. As such, relays 22 are sequentially opened if the source voltage sags below the source voltage limit and/or the source current exceeds the source current limit and opened relays 22 are sequentially reclosed if the source voltage exceeds the source voltage limit and the source current sags below the source current limit.

Specifically, a stage S60 of flowchart 60 encompasses power manager 40 closes all relays 22(1)-22(4), sets current relay N=1 and sets relay limit N_{MAX}. If a stage S62a of flowchart 60 indicates source voltage V_{SHI} is below source voltage limit V_{SVL} and/or stage S62b of flowchart 60 indicates source current I_{SHI} exceeds source current limit I_{SIL}, then power manager 40 only opens relay 22(N) and sets current relay N=N+1 during a stage S63 of flowchart 60. Thereafter, power manager 40 cycles through stages S63 and S64 of flowchart 60 until stage S64 indicates current relay N equals relay limit N_{MAX} whereby if a stage S65a of flowchart 60 indicates source voltage V_{SHI} exceeds source voltage limit V_{SVL} and stage S65b of flowchart 60 indicates source current I_{SHI} is below source current limit I_{SIL}, then power manager 40 initiates a sequential reopening of closed relays 22 during a stage S66 of flowchart 60. Power manager 40 will complete the sequential reopening of closed relays 22 and return to stage S61 if stage S65a of flowchart 60 continues to indicate source voltage V_{SHI} exceeds source voltage limit V_{SVL} and stage S65b of flowchart 60 continues to indicate source current I_{SHI} is below source current limit I_{SIL} during a relay countdown of stage S67 of flowchart 60. Otherwise, power manager 40 will return to stage S64 upon stage S65a of flowchart 60 indicating source voltage V_{SHI} is again below source voltage limit V_{SVL} and/or stage S65b of flowchart 60 indicating current I_{SHI} is again exceeding source current limit I_{SIl}.

Referring to FIG. 8, flowchart 70 represents a power management method of the present invention whereby relays 22 are opened in a priority sequence from relay 22(1) up to 22(4) in dependence a variable source voltage limit and a variable source current limit. As such, relays 22 are sequentially opened if the source voltage sags below an updated source voltage limit and/or the source current exceeds an updated source current limit and opened relays 22 are sequentially reclosed if the source voltage exceeds a previously updated source voltage limit and the source current sags below a previously updated source current limit.

Specifically, a stage S70 of flowchart 70 encompasses power manager 40 closes all relays 22(1)-22(4), sets current relay N=1 and sets the source voltage limit V_{VLN} and the source current limit I_{ILN} to their respective default values. If a stage S72a of flowchart 70 indicates source voltage V_{SHI} is below default source voltage lime V_{VLN} and/or stage S72b of flowchart 70 indicates source current _{Is} exceeds default source current limit I_{ILN}, then power manager 40 only opens relay 22(N), sets current relay N=N+1 and updates source voltage limit V_{VLN} and source current limit I_{ILN} during a stage S73 of flowchart 70. For stage S73, the limit updating includes decreasing both source voltage limit V_{VLN} and source current limit I_{ILN} by a specified amount to thereby prevent any unnecessary opening of any additional relays.

Thereafter, if a stage S74a of flowchart 70 indicates source voltage V_{SHI} is below the updated source voltage lime V_{VLN} and/or stage S74b of flowchart 70 indicates source current I_{SHI} exceeds updated source current limit I_{ILN}, then power manager 40 executes stage S73 again to open relay 22(N), set current relay N=N+1 and update source voltage limit V_{VLN} and the source current limit I_{ILN}. Power manager will cycle through stages S73 and S74 until such time stage S74 indicates source voltage V_{SHI} exceeds a previous source voltage limit V_{VLN} and/or stage S75b of flowchart 70 indicates source current I_{SHI} is below a previous source current limit I_{ILN}. Upon such indication(s), power manager 40 initiates a sequential reopening of closed relays 22 during a stage S76 of flowchart 70. Power manager 40 will complete the sequential reopening of closed relays 22 and return to stage S71 if stage S75a of flowchart 70 continues to indicate source voltage V_{SHI} exceeds a previous source voltage lime V_{VLN} and stage S75b of flowchart 70 continues to indicate source current I_{SHI} is below a previous source current limit I_{ILN} during a relay countdown of stage S77 of flowchart 70. Otherwise, power manager 40 will return to stages S74a and S74b upon stage S75a of flowchart 70 indicating source voltage V_{SHI} is again below a previous source voltage lime V_{VLN} and/or stage S75b of flowchart 70 indicating current I_{SHI} is again exceeding a previous source current limit I_{ILN}. Referring to FIG. 9, power manager 21(1) may alternatively be implemented as a power manager 40′ employing power sensor 41, EEPROM 42, RAM 43, ALU 44, and relay controls 45(1)-45(4) for selectively opening and closing relays 22(1)-22(4) as previously described herein for power manager 40 (FIG. 5). Power manager 40′ further employs a power sensor 46, a relay control 45(5) for selectively relaying a relay 22(5) between power source node PSN_{H1} and ground GND, and a relay control 46(6) for opening and closing a relay 22(6). ALU 44 implements a relay control of relays 22(5) and 22(6) based on a comparison of source power PWR_{H1} to a minimum backup voltage limit.

For example, as shown in FIG. 10, ALU 44 implements a flowchart 80 representative of a power management method whereby source power PWR_{H1} is continually compared to a minimum backup voltage limit V_{MIN} to thereby determine when source power PWR_{H1} or a backup power PWR_{BG} should be applied to power source node PSN_{H1}. Specifically, a stage S81 of flowchart 80 encompasses power manager 40′ relaying relay 22(5) to power source node PSN_{H1} and opening relay 22(6) whereby power manager 40′ executes either flowchart 50 (FIG. 6), flowchart 60 (FIG. 7) or flowchart 70 (FIG. 8) for source power PWR_{H1} as previously described herein. If a stage S82 of flowchart 80 indicates source power PWR_{H1} is below a minimum backup voltage limit V_{MIN} (e.g., zero volts during a power outage or a voltage ceiling insufficient to supply ample current to any connected load circuit(s)), then power manager 40′ proceeds to a stage S83 of flowchart 80 to relay 22(5) to ground and close relay 22(6) whereby power manager 40′ executes either flowchart 50, flowchart 60 or flowchart 70 for backup power PWR_{BG} in view of backup voltage V_{BG} and backup current I_{BG} as sensed by power sensor 46 as shown in FIG. 9.

Referring again to FIG. 10, power manager 40′ will transition between stages S81 and S83 in dependence upon the comparison of source power PWR_{H1} to minimum backup voltage limit V_{MIN} during stage S82.

In practice, backup generator 30 may be activated by any suitable means during stage S83. For example, the closing of relay 22(6) may activate backup generator 30. Also by example, ALU 44 may provide an activation signal (not shown) to backup generator 30 during stage S83.

From the description of FIGS. 1-10, those having skill in the art will have a further appreciation on how to construct and use any type of building power management system in accordance with the inventive principles of the present invention.

While the illustrations of FIGS. 1-10 described power management of both a source voltage and source current, in practice those having skill in the art may implement a power management of the present invention exclusively for source voltage or exclusively for source current.

Also, in practice, the time between stages of the flowcharts shown in FIGS. 6-8 and 10 may vary in dependence of the application of the power management of the present invention.

FIG. 11 illustrates a power management system employing a power circuit 90 having an X number of relays 91 for selectively applying a source power PWR_{S} to a X number of loads 100, X being ≧1. The power management system further employs a power manager 110 for communicating power command signal(s) 121 to power circuit 90, a local workstation 110 for communicating command signal(s) 123 to power manager 110, and a remote workstation 113 for communicating command signal(s) 124 to power manager 110 via a network 112. In addition, power manager 110 communicates power status information 122 to local workstation 111 and remote workstation 113.

In operation, power manager 110 receives power status signal(s) 120 from power circuit 90 to determine if an operational load condition or a shed load condition applies to each circuit. For purposes of the present invention, power status signal(s) 121 include any signal(s) indicative of an application of source power PWRₛ to load(s) 100 via relay(s) 91, the term “operational load condition” is defined as a voltage applied to power circuit 90 or a load 100 as being greater than a shed voltage threshold and a current flowing through a load 100 being less than a shed current threshold, and the term “shed load condition” is defined as a voltage applied to power circuit 90 or a load 100 as being less than the shed voltage threshold or a current flowing through a load 100 being greater than the a shed current threshold.

Also, for purposes of the present invention, command signal(s) 122 includes any signal(s) indicative of an operational mode of power manager 110 among a Y number of operational modes, Y being ≧1. In practice, the operational modes includes a load management mode for implementing a power management method of the present invention and includes an unlimited number of additional modes of any type of subject matter.

FIG. 12 illustrates a flowchart 130 representative of a power circuit control method of the present invention. Flowchart 130 will be described in the context of the operational modes being the load management mode, a time priority mode and a manual override mode.

At the start of flowchart 130, a stage S131 of flowchart 130 encompasses power manager 110 transitioning each closed relay 91 to an open state prior to an application of source power PWR_{S} to a corresponding load 100.

A stage S132 of flowchart encompasses a determination by power manager 110 as to whether each relay 91 on an individual basis should remain in the open state or be transitioned to a closed state in dependence of a Y number of mode signals 134 inclusive of any combination of power status signal(s) 120 and command signal(s) 122.

If the mode signals 134 indicate local workstation 111 or remote workstation 113 commands power manager 110 to implement a power management method of the present invention, then power manager 110 communicates a power command signal 121 to power circuit 90 for transitioning each opened relay 91 associated with a load 100 having an operational load condition to the closed state (stage S133) and for transitioning each closed relay 91 associated with a load 100 having a shed load condition to the open state (stage S131).

If local workstation 111 or remote workstation 113 commands power manager 110 via a command signal 122 to implement a time priority method, then power manager 110 communicates power command signal(s) to power circuit 90 for opening each relay 91 in response to the local time being within an offline time range for power circuit 90 (e.g., off-duty hours) (stage S131) and for implementing the power management method of the present invention in response to the local time being outside of the offline range (i.e., within an online time range) for power circuit 90 (e.g., on-duty hours) (stages S131/S133).

If local workstation 111 or remote workstation 113 commands power manager 110 via a command signal 122 to implement a manual override, then power manager 110 communicates power command signal(s) to power circuit 90 for opening each relay 91 in response to the manual override command (S131) and for implementing the power management method of the present invention in absence of the manual override command (stages S131/S133).

To facilitate an understanding of the power management system of FIG. 11, an exemplary embodiment of a command structure (FIG. 13) and a status structure (FIG. 14) of the power management system will now be described herein.

Referring to FIG. 13, for each relay 91 and associated load 100, the command structure employs a voltage sensor 140, a current sensor 141, a SR flip-flop 142, an open OR gate 143, a close OR gate 144, a load controller 145, a time controller 146, a manual override controller 147, a command controller 148, a local command module 149, and a remote command module 150.

In practice, SR flip-flop 142, open OR gate 143, close OR gate 144, load controller 145, time controller 146, manual override controller 147, and command controller 148 are installed within power manager 110 (FIG. 11). Additionally, local command module 149 is installed within local workstation 111 (FIG. 11) and remote command module 150 is installed within remote workstation 113 (FIG. 11).

In operation, command controller 148 selectively exclusively enables one of load controller 145, time controller 146 and manual override controller 147 via respective enable signals E_{LC}, E_{TC} and E_{MO}.

When exclusively enabled, load controller 145 inputs voltage sensing signal V_{SS} and current sensing signal I_{SS} to ascertain whether load 100 is experiencing a transition from an operational load condition (i.e., V_{SS}>V_{TH} and I_{SS}<I_{TH}) to a shed load condition (i.e., V_{SS}≦V_{TH} or I_{SS}≧I_{TH}), or vice-versa. If load 100 is experiencing a transition to an operational load condition, then load controller 145 pulses a close state signal C to close OR gate 144 whereby relay 91 is transitioned to a closed state, and if load 100 is experiencing a transition to a shed load condition, then load controller 145 pulses an open state signal 0 to open OR gate 143 whereby relay 91 is transitioned to an open state.

When exclusively enabled, time controller 146 ascertains whether load 100 is experiencing a transition from an online time range to an offline time range or vice-versa. If load 100 is experiencing a transition to an online time range, then time controller 146 pulses a close state signal C to close OR gate 144 whereby relay 91 is transitioned to a closed state, and if load 100 is experiencing a transition to an offline time range, then time controller 146 pulses an open state signal O to open OR gate 143 whereby relay 91 is transitioned to an open state.

When exclusively enabled, manual override controller 147 ascertains whether load 100 is experiencing a transition from a manual override to a normal operation or vice-versa. If load 100 is experiencing a transition to a normal operation, then manual override controller 147 pulses a close state signal C to close OR gate 134 whereby relay 91 is transitioned to a closed state, and if load 100 is experiencing a transition to a manual override, then manual override controller 147 pulses an open state signal O to open OR gate 133 whereby relay 91 is transitioned to an open state.

In deciding which controller to enable, command controller 148 has a priority of (1) manual override, (2) time of day and (3) power management. A command to manually override the power circuit is received from local command module 149 or remote command module 150 via respective override command signals OR_{L} and OR_{R}. In the absence of the override command signals, command controller 148 enables time controller 146 if the current time of day is within the offline time range or alternatively enables load controller 145 if the current time of day is outside of the offline time range.

In practice, each relay 91 and load 100 and corresponding voltage sensor 140, current sensor 141 SR flip-flop 142, and OR gates 143/144 constitute a power circuit. Furthermore, load controller 145, time controller 146 and manual override controller 147 are connected to each power circuit.

Referring to FIG. 14, for each relay 91 and associated load 100, the status structure employs a status monitor 151 in conjunction with load controller 145, time controller 146 and manual override controller 147. The status structure further employs a local display 152 within local workstation 111 (FIG. 11) and a remote display 153 within a remote workstation 113 (FIG. 11).

In operation, status monitor 151 receives voltage sensing signal V_{SS}, current sensing signal I_{SS}, relay status signal V_{RS} and pulse status signal V_{PS} to communicate a power status signal S_{PS} to local display 152 and remote display 153. The power status signal S_{PS} is indicative of a current state of relay 91.

When enabled, load controller 145 communicates a load status signal S_{LS} to local display 152 and remote display 153. The load status signal S_{LS} is indicative of a load condition of relay 91.

When enabled, time controller 146 communicates a time status signal S_{TS} to local display 152 and remote display 153. The time status signal S_{TS} is indicative of an offline or an online status of the power circuit.

When enabled, manual override controller 147 communicates an override status signal S_{OS} to local display 152 and remote display 153. The override status signal S_{OS} is indicative of a presence or an absence of the manual override signal.

The processing of all of the status signals enables a user of local display 152 and a user of remote display 153 to get a current and a historical monitoring of each power circuit.

For purposes of the present invention, the term “relay” and the term “switch” are interchangeable.

While various exemplary embodiments of the present invention have been illustrated and described, it will be understood by those skilled in the art that the exemplary embodiments of the present invention as described herein are illustrative, and various changes and modifications may be made and equivalents may be substituted for elements thereof without departing from the true scope of the present invention. In addition, many modifications may be made to adapt the teachings of the present invention without departing from its central scope. Therefore, it is intended that the present invention not be limited to the particular embodiments disclosed as the best mode contemplated for carrying out the present invention, but that the present invention includes all embodiments falling within the scope of the appended claims.

1. A building power management system, comprising:
a plurality of load circuits; and
a power manager operable coupled to the load circuits,
wherein the power manager is operable for sensing a source voltage at a power source node, for shedding at least one of the load circuits from the power source node in response to the source voltage sagging below a source voltage limit, and for reconnecting each shedded load circuit to the power source node upon the source voltage exceeding the source voltage limit; and
wherein the program manager senses is further operable for sensing a source current flowing through the power source node, for shedding at least one of the load circuits from the power source node in response to the source current exceeding a source current limit, and for reconnecting each shedded load circuit to the power source node upon the source current sagging below the source current limit.

2. The building power management system of claim 1, wherein the load circuits are at least partially connected in parallel to the power source node.

3. The building power management system of claim 1, wherein the load circuits are at least partially connected in series to the power source node.

4. The building power management system of claim 1, further comprising:
a surge protector operably operably coupling the power source node to the power manager and the load circuits.

5. The building power management system of claim 1, further comprising:
a backup power generator operably coupled to the power source node to the power manager and the load circuits.

6. The building power management system of claim 1, wherein the power manager sheds a maximum number of load circuits in response to the source voltage sagging below a source voltage limit, the maximum number of load circuits being less than a total number of load circuits.

7. The building power management system of claim 1, wherein the power manager sheds a maximum number of load circuits in response to the source current exceeding a source current limit, the maximum number of load circuits being less than a total number of load circuits.

8. The building power management system of claim 1, wherein the power manager sheds a maximum number of load circuits in response to the source current exceeding a source current limit, the maximum number of load circuits being less than a total number of load circuits.

9. The building power management system of claim 1, wherein the power manager decrease the source voltage limit in response to reaching a specific number of shedded load circuits.

10. The building power management system of claim 1, wherein the power manager increases the source voltage limit in response to reaching a specific number of shedded load circuits.

11. A power network, comprising:
a plurality of load circuits; and
a plurality of power circuits, each power circuit including:
a relay operable coupling one of the plurality of load circuits to a power source node,
a source voltage sensor operably coupled to the power source node,
a source current sensor operably coupled between the relay and the load circuit, and
a pulsing circuit operably coupled to the relay; and
a power manager operable to communicate a power command signal to the pulsing circuit for selectively transitioning the relay between an open state and a closed state.

12. The power network of claim 11,
wherein the power command signal indicates an operational load condition in response to a voltage sensing signal being greater than a source voltage threshold and a current sensing signal being less than a source current threshold, and
wherein the power command signal indicates a shed load condition in response to one of the voltage sensing signal being less than the source voltage threshold and the current sensing signal being greater than the source current threshold.

13. The power network of claim 11,
wherein the power command signal indicates an operational load condition in response to a current time of day being within an online time range, and
wherein the power command signal indicates a shed load condition in response to the current time of day being within an offline time range.

14. The power network of claim 11,
wherein the power command signal indicates an operational load condition in an absence of a manual override command, and
wherein the power command signal indicates a shed load condition in response to the manual override command.

15. The power network of claim 11, wherein the power manager communicates at least one command signal to at least one of a local workstation and a remote workstation.

16. The power network of claim 15, wherein at least one of the local workstation and the remote workstation is operable to communicate a manual override to the power manager.
